(19) United States
(12) Patent Application Publication
(10) Pub. No.: US 2004/0125029 A1
(43) Pub. Date: Jul. 1, 2004

(54) Apparatus and method for enhancing low-frequency operation of mobile communication antennas

(76) Inventors: Joseph Maoz, Tel Aviv (IL); Michael Kadichevitz, Tel Aviv (IL)

Correspondence Address: Anthony Castorina, G E Ehrlich, Suite 207, 2001 Jefferson Davis Highway, Arlington, VA, 22202, US

(21) Appl. No.: 10/362,219

(22) PCT Filed: Aug. 16, 2001
(86) PCT No.: PCT/IL01/00767

(51) Int. Cl. H01Q 1/24

(52) U.S. Cl. 343/702; 343/846

(57) ABSTRACT

The operation of a mobile communication apparatus is enhanced particularly in the lower frequency portion of its bandwidth by connecting an electrically-conductive reflector to the electrically-conductive ground of the printed wired board (PWB) containing the communication circuitry such that the reflector effectively enlarges the ground of the PWB to load the antenna in the lower portion of its radio frequency band. The reflector may include stub reflectors integrally formed on the PWB, or connected thereto, preferably at the end of the PWB opposite to that connected to the antenna. The antenna may be an internal antenna or an external antenna.

### FIELD AND BACKGROUND OF THE INVENTION

The present invention relates to apparatus, and also to a method, for enhancing the operation of mobile communication antennas particularly in the low-frequency portion of the bandwidth or bandwidths for which the apparatus was designed. The invention is particularly useful in mobile communication apparatus (such as mobile telephone handsets) having built-in internal antennas or external antennas, and is therefore described below particularly for such applications.

### BACKGROUND OF THE INVENTION

Mobile communication equipment, including their antennas, are becoming smaller in size as the technology is developed. For an antenna to operate properly, it should usually be about half a wavelength in size, except for monopole-like antennas (which normally operate above a ground plane) where a quarter wavelength is required. For advanced mobile communication devices, e.g., cellular telephone handsets, such dimensions are impractical since the overall handset dimensions are smaller than half a wavelength of the appropriate frequency.

Using small antennas therefore reduces their efficiency, and accordingly requires higher power to be supplied. Higher power reduces the intervals between battery recharges, and increases the radiation into the user's head/body. The level of power radiated into the human head is particularly significant, and serious limitations and specifications are prescribed in order to reduce this possible hazard to the users.

Operation of such devices in the vicinity of a human body also changes the field and/or current distribution along the antenna, and hence changes its radiation pattern, as well as the radiation efficiency. Practically speaking, the reduction in efficiency may be in the range of 10-20 dB or more. External whip antennas, such as the “STUBBY” or retractable antennas, are commonly used to increase the antenna efficiency. However, the use of such antennas is also inconvenient as the antennas are often “caught up” inside the pocket. They also detract from the aesthetic appearance of the mobile communication device. Moreover, their radiation pattern is quasi-omni so as to provide little protection of the user's head/body against excessive radiation.

Internal antennas supplied by several companies are relatively inefficient as compared to external antennas. Furthermore, these known internal antennas generally do not decrease the radiation into the user's head/body, and in many cases even increase such radiation. The antenna gain is also generally poor (especially while used adjacent to the head/body), and the SAR (Specific Absorption Ratio) results are generally high.

A particular problem in the known internal antennas is their narrow bandwidth of operation. In addition, where the input impedance is unmatched, the radiation efficiency is even further reduced. The latter is considered an even more difficult problem in cases where dual-frequency bands, triple-frequency bands, or other multi-band operations of the mobile communication devices are required, such as cellular GSM 900/1800, 900/1900, 900/1800/1900 MHz, etc., or in GPRS (2.5 G) and UMTS (3 G) applications where bandwidth is the key for operation. Further, bandwidth is generally important for all mobile communication applications, in order to maximize the overall system capacity.

Internal antennas for mobile communication apparatus are known that utilize printed constructions, e.g. patches and slots. These are very convenient to use because of their ease of manufacture, their low profile, and their low production cost. Examples of known internal antenna constructions are described in U.S. Pat. Nos. 5,068,670, 5,929,813, 5,945,954, 6,002,367, and 6,025,802, and in European Patent EP 0924797. If such printed elements could be used in mobile communication devices with respect to efficiency, gain, impedance matching and reproducibility, it would be the best choice. Unfortunately, such elements, because of the small size of the mobile communication device, show very low efficiency and hence low gain; moreover it is difficult to match their impedance to that of the mobile communication device.

The present invention is particularly directed to mobile communication apparatus which includes a housing containing a printed circuit board, or PCB (now more commonly referred to as a printed wired board or PWB, which term will be hereafter used) carrying the communication circuitry and formed with a signal terminal and an electrically-conductive ground for the communication circuitry. Such apparatus further includes an antenna carried internally within the housing, or externally of the housing, and electrically-connected to the signal terminal, and optionally also to the ground of the communication circuitry on the PWB within the housing. While such antennas may be designed in a relatively small and compact form for relatively high radio frequency bands, their operation at low radio frequency bands is relatively inefficient. Where the antenna is very small, the printed wired board (PWB) carrying the communication circuitry of the mobile communication apparatus actually serves as an extension of the antenna, and enhances its efficiency and bandwidth. However, since mobile communication devices are becoming smaller in size, this contribution of the PWB to the antenna performance is limited. This limitation applies to all kinds of antennas used with such mobile communication apparatus, i.e., internal antennas as well as external antennas.

### OBJECTS AND BRIEF SUMMARY OF THE INVENTION

An object of the present invention is to provide mobile communication apparatus including small, compact antennas, wherein the operating efficiency and bandwidth of the antenna are enhanced. Another object of the invention is to provide a method of enhancing the operating efficiency of such antennas.

According to one aspect of the present invention, there is provided mobile communication apparatus, comprising: a housing including communication circuitry and a printed wired board (PWB) formed with a signal terminal for an antenna, and an electrically-conductive ground for the communication circuitry; an antenna carried by the housing and electrically connected to the signal terminal of the communication circuitry in the PWB (and optionally to the ground), the antenna being designed to operate in at least one radio frequency band; and an electrically-conductive reflector carried by the PWB and electrically connected to the electrically-conductive ground of the PWB such that the electrically-conductive reflector effectively enlarges the ground of the PWB to load the antenna in said radio frequency band and thereby to enhance the operating efficiency of the antenna particularly in the lower part of said radio frequency band and/or to widen said radio frequency band.

Many embodiments of the invention are described below for purposes of example.

According to further features in the described preferred embodiments, the antenna is connected to the signal terminal of the communication circuitry at one end of the PWB, and the electrically-conductive reflector is connected to the ground of the communication circuitry at the opposite end of the PWB. The reflector may be carried on a separate board from the PWB and electrically connected to the ground of the communication circuitry at the opposite end of the PWB. Since the electrically-conductive reflector may be added without enlarging the physical size of the PWB, this enhancement of the operation, and/or widening of the bandwidth, of the mobile communication apparatus can be effected without any significant increase in the physical size of the overall apparatus.

According to further features in some of the described preferred embodiments, the reflector includes a pair of stub reflectors formed in the electrically-conductive ground of the PWB at the opposite end of the PWB. In some described preferred embodiments, the opposite end of the PWB includes an electrically-conductive ground on one layer of the PWB, the stub reflectors being defined by slots formed in the electrically-conductive ground on the one layer. The stub reflectors may be symmetrical or asymmetrical and may have open or shorted ends, according to the particular application.

A further embodiment is described wherein the ground of the communication circuitry is carried on one layer of the PWB, and the reflector is carried on another layer of the PWB.

According to another preferred embodiment described below, the electrically-conductive reflector is included in a box having a plurality, e.g., six, sides overlying one end of the PWB, at least one of the sides of the box being electrically-conductive and serving as the reflector electrically connected to the ground of the PWB.

According to another aspect of the present invention, there is provided a method of enhancing the operational efficiency of a mobile communication apparatus in at least one radio frequency band, or to widen its radio frequency band, which apparatus comprises a housing including communication circuitry and a printed wired board (PWB) formed with a signal terminal for an antenna and an electrically-conductive ground for the communication circuitry, and an antenna carried by the housing and electrically connected to the signal terminal of the communication circuitry in the PWB; characterized in that the operating efficiency of the antenna is enhanced, particularly in the lower portion of the radio frequency band, or its radio frequency band is widened by connecting an electrically-conductive reflector to the electrically-conductive ground of the PWB such that the electrically-conductive reflector effectively enlarges the ground of the PWB to load the antenna in the radio frequency band.

In case of two or more operational frequency bands, the performance enhancement (i.e., the antenna gain) would practically be applied to the lower band. That is, the higher frequency bands (e.g., 1800 or 1900 MHz) do not always need this extension for normal operation, and only the lower bands (e.g., 800 or 900 MHz) will be enhanced. However, the addition of the reflector or the stub-reflectors may also enhance the bandwidth of all the operation bands in that it also adjusts the antenna operational frequency down to the required lower frequency band.

As indicated earlier, the apparatus and method of the present invention are applicable to both internal antennas as well as to external antennas.

Further features and advantages of the invention will be apparent from the description below.

### BRIEF DESCRIPTION OF THE DRAWINGS

The invention is herein described, by way of example only, with reference to the accompanying drawings, wherein:

FIG. 1 is an exploded view illustrating one form of mobile communication apparatus constructed in accordance with the present invention;

FIG. 2 illustrates an example of an internal antenna which may be used in the apparatus of FIG. 1;

FIG. 3 illustrates one arrangement in accordance with the present invention for enhancing the operating efficiency of the antenna in the apparatus of FIGS. 1 and 2 in the lower radio frequency band, FIGS. 3a, 3b and 3c being side views illustrating possible locations of the reflector;

FIGS. 4, 4a, 4b and 4c are views, corresponding to those of FIGS. 3, 3a, 3b and 3c, respectively, illustrating another arrangement in accordance with the present invention for enhancing the operating efficiency of the antenna in the lower radio frequency band;

FIGS. 5a and 5b are views of the opposite faces of the PWB in the apparatus of FIGS. 1 and 2 illustrating a further arrangement in accordance with the present invention for enhancing the operating efficiency of the antenna in the lower radio frequency band;

FIGS. 6a, 6b, 7a, 7b and 8a, 8b are views corresponding to those of FIGS. 5a and 5b, respectively, illustrating three other arrangements that may be used in accordance with the present invention;

FIG. 9 illustrates a still further arrangement wherein the electrically-conductive reflector is in the form of a box having one or more electrically-conductive faces, FIG. 9a illustrating one example of such a box construction, and FIGS. 9b and 9c illustrating alternative dispositions of the box with respect to the PWB;

FIGS. 10, 10a, 10b, and 10c are views, corresponding to those of FIGS. 3, 3a, 3b and 3c, respectively, illustrating an arrangement similar to that of FIG. 3 but wherein the antenna is an external antenna, rather than an internal antenna; and

FIGS. 11a and 11b illustrate the invention implemented in a mobile telephone handset having an external antenna, FIG. 11a illustrating the closed position of the handset and FIG. 11b illustrating the open position of the handset.

### DESCRIPTION OF PREFERRED EMBODIMENTS

With reference first to FIG. 1, there is illustrated one form of mobile communication apparatus constructed in accordance with the present invention, including a housing, generally designated 2, constituted of a front cover 3 and a back cover 5. Within housing 2 is a printed wired board (PWB) 4, sometimes referred to as a printed circuit board (PCB), which includes all or a part of the communication circuitry, generally designated 6, of the apparatus. PWB 4 is formed with a signal terminal indicated at 7, and with an electrically-conductive ground connected to ground terminals 8, 9 for the communication circuitry. The ground may be a continuous conductive layer serving as a ground plane, or may be one or more conductive strips serving as a ground for individual components of the communication circuitry.

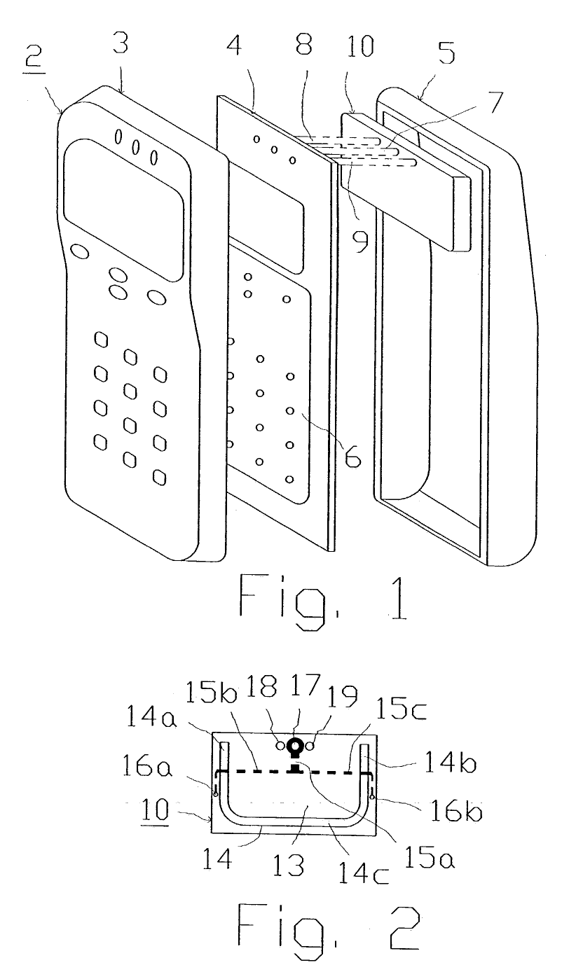

In the apparatus illustrated in FIG. 1, terminals 7-9 are on the underlying surface of PWB 4 and face an internal antenna, generally designated 10, covering a portion of the PWB 4. The internal antenna 10 may be of any desired construction. FIG. 2 illustrates one construction, for purposes of example, which is similar to one of those described in our International Patent Application PCT IL/01/00626 filed 9 Jul. 2001.

Thus, as more particularly shown in FIG. 2, internal antenna 10 includes a PWB constituted of a dielectric substrate having an electrically-conductive layer 13 on one face, serving as the ground plane and cut with a radiant slot 14. Slot 14 is of a curved U-shaped configuration, closed at both of its ends, to define two closed side arms 14a, 14b joined by a bridge 14c. Radiant slot 14 is excited by an electrically-conductive feed line 15 carried on the opposite face of the dielectric panel and therefore indicated by broken lines in FIG. 2.

The antenna illustrated in FIG. 2 is of a symmetrical construction, wherein the two side arms 14a, 14b are substantially parallel and of substantially the same length and width, and are excited by common excitation point, namely the point where the feed line 15 crosses the slot 14.

The illustrated antenna has a signal input terminal 17 electrically connected to the signal terminal 7 of the PWB 4 (FIG. 1), and two ground terminals 18, 19, electrically connected to the two ground terminals 8, 9 of the PWB 4. These electrical connections may be by pins passing through plated-through-holes (PTHs) or the like. The feed line 15 (shown in broken lines in FIG. 2 since it is on the opposite face of the antenna panel 10) includes a main feed line arm 15a connected to the input signal terminal 17. Feed line arm 15a divides the power into two feed line transformer sections 15b, 15c, exciting the slot 14 at two points. The transformer sections 15b and 15c continue from the excitation points underneath the slot and perform the function of reactive loads which are shorted to the ground 13, as shown at 16a, 16b. These reactive loads enhance and improve the matching of the slot impedance; that is, they mainly reduce the reactive part of the slot impedance to the order of zero at a broad frequency range.

Further features of the construction and operation of the internal antenna 10 illustrated in FIGS. 1 and 2, as well as alternative constructions that may be used, are described in the above-cited PCT Application PCT/L01/00626, filed 9 Jul. 2001, the contents of which are hereby incorporated by reference.

In the above-cited PCT Application, the antenna is made resonant and radiant not only at a predetermined high frequency, as determined by the parameters of slot 14, the feed line 15, and the reactive loads, but also at a lower frequency band so as to be capable of use as a multi-band microwave antenna. In the above-cited PCT Application, this is done by providing an extension in the form of stub reflectors, or by providing a further panel serving as a continuation of the ground plane 13 at the load side of the slot 14, and thereby effectively enlarging the ground plane to load the antenna in a lower radio frequency band, such as to enhance the operating efficiency of the antenna in the lower radio frequency band.

In the present application, a similar technique is used but with respect to the main PWB 4 of the handset 2. This is done by extending the electrically-conductive ground of the printed wired board (PWB) 4 containing the communication circuitry 6, either with an external panel or with stub-reflectors electrically connected to that ground, so as to effectively enlarge that ground. This effectively loads the antenna in the lower radio frequency band, and thereby enhances the operating efficiency of the antenna in the lower radio frequency band and/or widens that band.

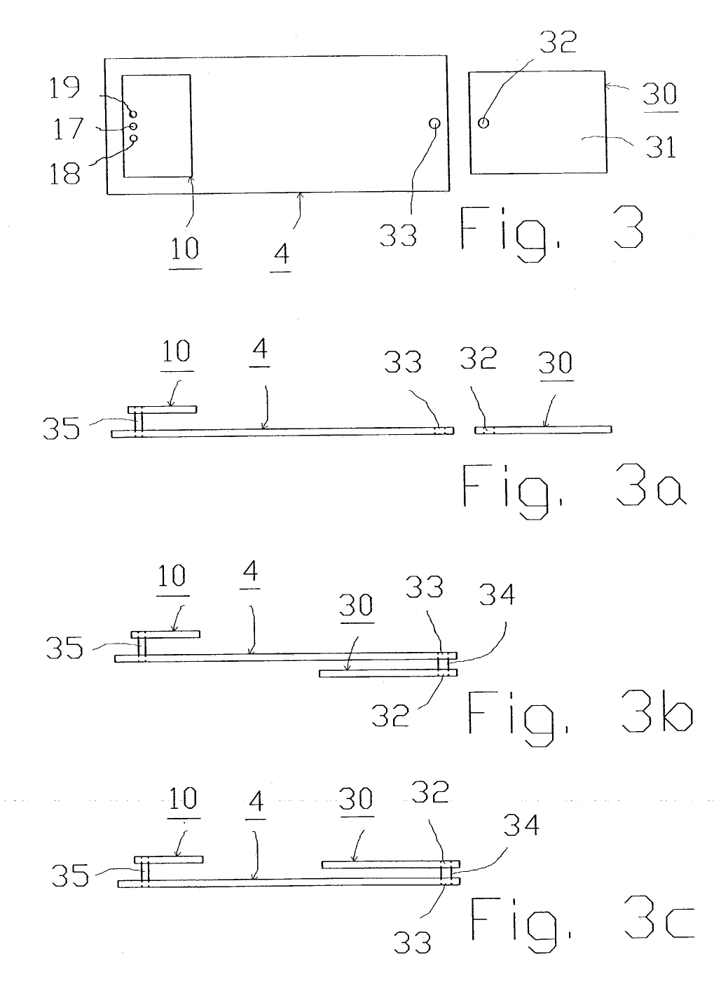

FIG. 3 illustrates an arrangement wherein the electrically-conductive reflector, generally designated 30, is attached to the PWB 4 carrying the internal antenna 10. The reflector 30 is in the form of an insulating panel carrying an electrical-conductive layer 31 on one face. It is electrically connected by a terminal 32 to a terminal 33 on the PWB 4 at the end of the PWB opposite to that carrying the internal antenna 10 and the signal terminal 7 of the PWB connected to the signal terminal 17 of the internal antenna. The connection between terminals 32 and 33 may be by pin 34 (FIGS. 3b, 3c); and the connections between the terminals 7-9 of the PWB 4 and terminals 17-19 of the internal antenna 10 may be by pins 35.

FIG. 3a illustrates the initial stage in the preparation of the reflector 30; FIG. 3b illustrates the application of the reflector to underlie the respective end of the PWB 4; and FIG. 3c illustrates the application of the reflector to overlie the respective end of the PWB 4.

It will thus be seen that the reflector 30 acts as a load to the antenna in the lower operational band, by enlarging the ground plane of the main PWB 4 (and thereby of the antenna 10). As described above, this improving antenna matching and enhances the operating efficiency of the antenna in the lower radio frequency band. The dimensions and shape of the reflector 30, as well as the distance from the PWB 4, may vary. Although the reflector is shown in FIGS. 3b and 3c as parallel to the main PWB 4, it may be mounted to the latter at any desired angle. The reflector may be made in any suitable manner, such as by providing a conductive layer on an insulating board, by using a metal plate, metallic paint, metal plated plastic, etc. It may also be an independent part of the apparatus, such as a part of the battery, the housing cover, the keyboard, etc.

It will also be appreciated that the antenna 10 may also be connected to the ground of the PWB 4, in addition to its connection to the signal terminal 17 of the PWB 4.

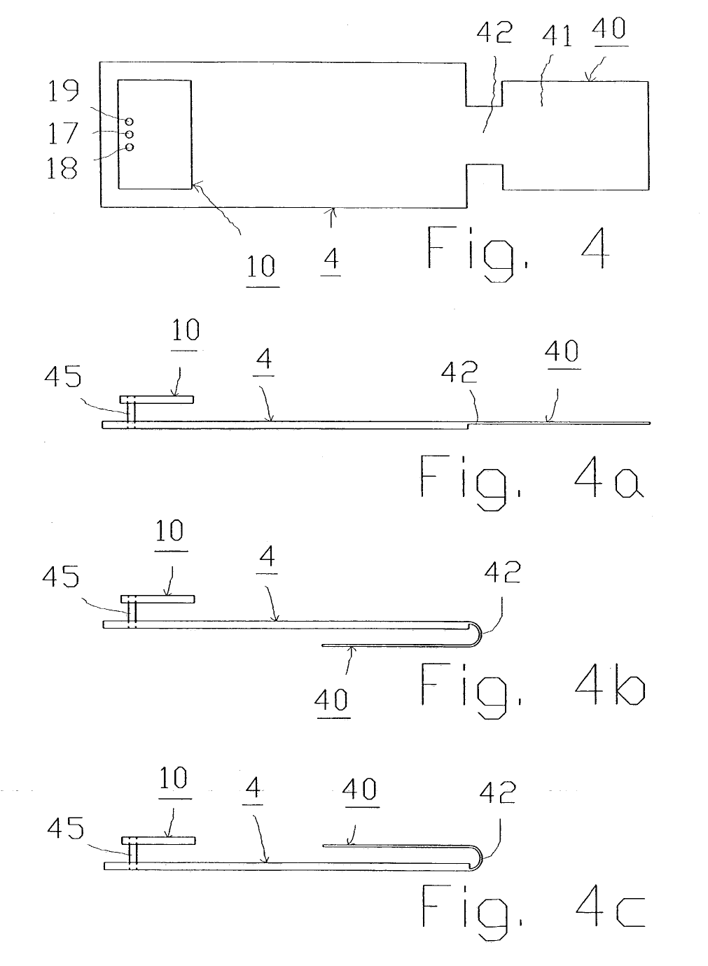

FIG. 4 illustrates a reflector, generally designated 40, constructed as a flexible part of the PWB 4, or of the conductive layer of that board, at the opposite end carrying the internal antenna 10 and the input signal terminals 7 of the PWB 4, and the corresponding terminal 17 of the internal antenna. The reflector 40 illustrated in FIG. 4 thus also includes an electrically-conductive layer 41 which is connected by a flexible strip 42 to the electrically-conductive layer of the PWB 4. Preferably, the reflector 40 is bent under the respective end of the PWB 4 (FIG. 4b), or over the respective end of the PWB 4 (FIG. 4c) or at any angle thereto, to provide a compact arrangement for the PWB 4 which enhances the operating efficiency of the antenna in the lower radio frequency band, as described above. The antenna 10 is connected to the PWB 4 in any suitable manner, such as by pins 45 passing through the signal terminal 17 and ground terminals 18, 19 in the antenna, and the corresponding terminals 7-9 (FIG. 1) in the PWB 4.

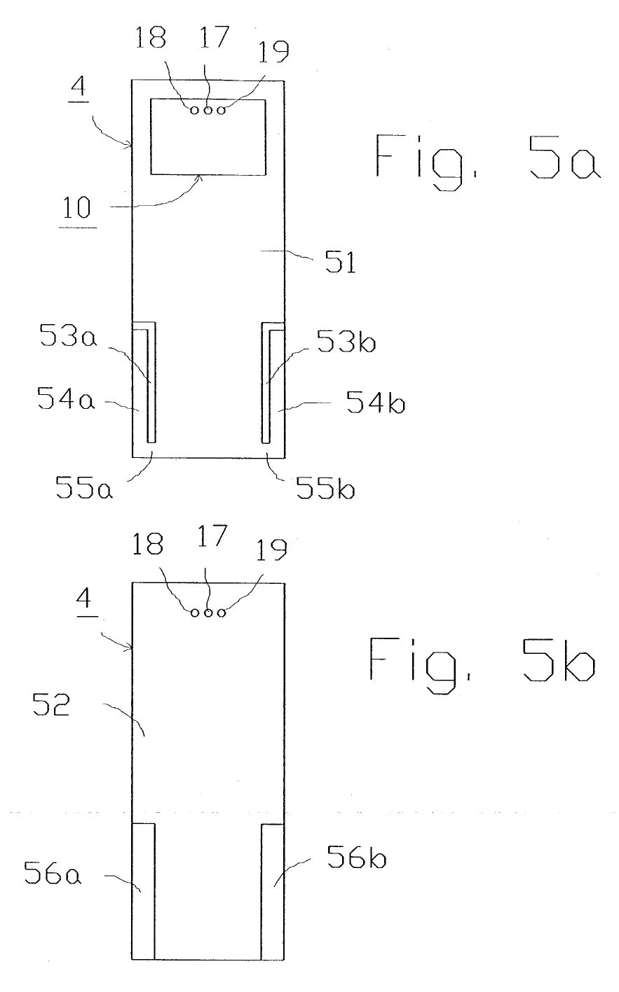

FIGS. 5a and 5b illustrate a construction wherein the electrically-conductive reflector is in the form of stub reflectors formed in the end of the PWB 4 opposite to that carrying the internal antenna 10 and the signal input terminal 17 of the antenna. In this case, the PWB 4 is provided with an electrically-conductive layer on both of its opposite faces, as shown at 51 in FIGS. 5a and 52 in FIG. 5b. The face 51, shown in FIG. 5a, which carries the internal antenna 10, is formed, at the opposite end from that carrying the internal antenna 10, with a pair of slots 53a, 53b, cut in the conductive layer 51 defining the ground plane. Each of the slots 53a, 53b is closed at one end and open at the opposite end to define two stub reflectors 54a, 54b, and electrical connections 55a, 55b at the ground plane 51. The electrically-conductive layer 52 on the opposite face of the PWB 4 (as shown in FIG. 5b) is formed with two interruptions 56a, 56b i.e., areas without conductors, in the ground plane 52 in alignment with the stub reflectors 54a, 54b.

The stub reflectors 54a, 54b, thus act similarly to the reflector 30 in FIG. 3, to effectively enlarge the ground plane 51 of the PWB 4, but better enable tuning to enhance the operating efficiency of the antenna in the lower radio frequency band.

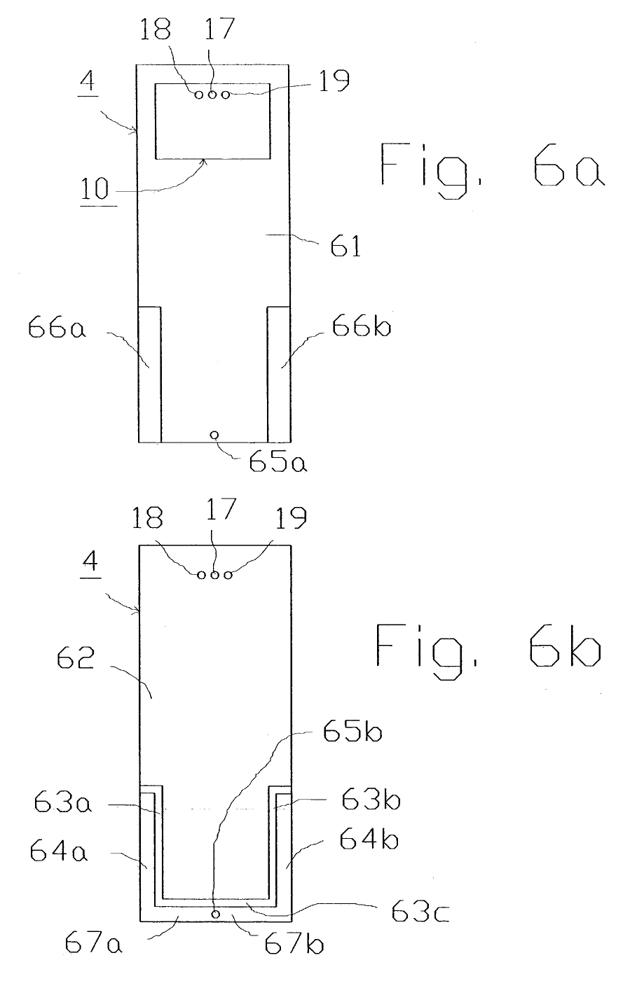

FIGS. 6a and 6b illustrate a construction similar to that of FIGS. 5a and 5b, except that the stub reflectors and the interruptions are reversed with respect to the opposite faces of the PWB 4. Thus, as shown in FIG. 6a, the electrically-conductive layer 61 on the side of PWB 4 carrying the internal antenna 10 is formed with the interruptions 66a, 66b; whereas the opposite face of the PWB 4 carrying the electrically-conductive layer 62 is formed with the slots 63a, 63b, defining the stub reflectors 64a, 64b. The electrical connections for exciting the stub reflectors 64a, 64b are in the form of PTHs 65a, 65b, and the conductive portions 67a, 67b of layer 62 electrically connecting conductive layer 61 to the stub reflectors 64a, 64b; while the slots 63a, 63b insulate the stub reflectors from the electrically-conductive layer 62.

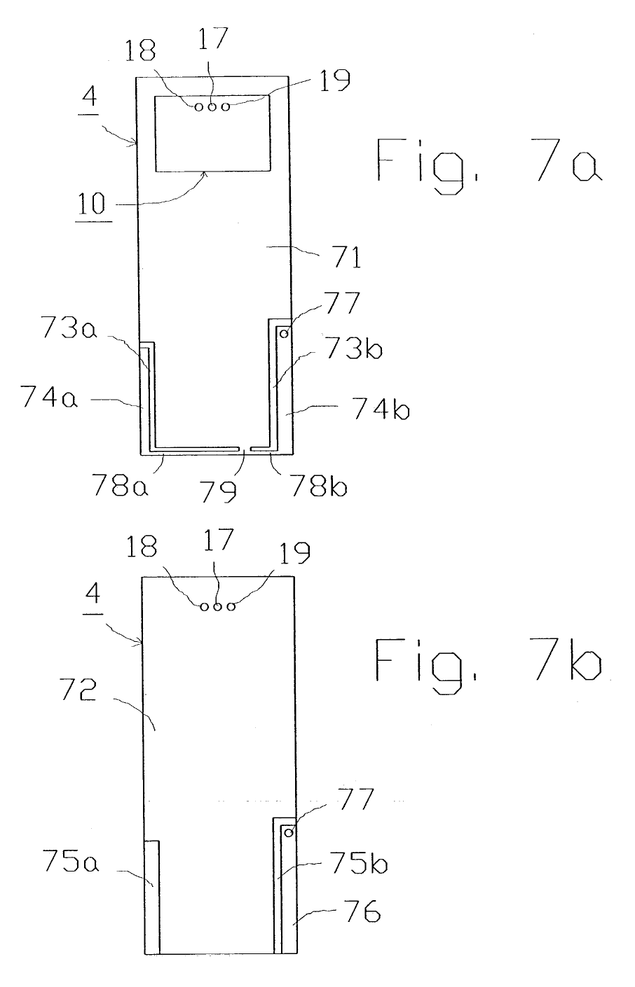

FIGS. 7a and 7b illustrate an arrangement also similar to that of FIGS. 5a and 5b, respectively, but wherein the two stub reflectors are of an asymmetrical construction. Thus, as shown in FIG. 7a, the slots 73a, 73b, are cut in the electrically-conductive layer 71 of the PWB 4 in the form of two half-closed slots of different configurations so as to define two stub reflectors 74a, 74b of different configurations and electrically connected to the electrically-conductive layer 71 (serving as the ground) by electrical connections 78a, 78b also of different configurations. Interruption 75a in the electrically-conductive layer 72 on the opposite face of the PWB 4 is of a rectangular configuration, whereas interruption 75b is of an L-shaped configuration such as to define a reflector extension 76 on face 72 (FIG. 7b). Reflector extension 76 is electrically connected by a plated-through-hole 77 (or pin, etc) to the stub reflector 74b on the opposite face of the PWB 4. The electrical connections 78a, 78b to the stub reflectors are separated by gap 79 in the two slots 73a, 73b.

By controlling the location, width and length of the gap 79, and the width and length of each stub reflector 74a, 74b, each half open slot 73a, 73b, each electrical connection 78a, 78b, the ground interruption 75a, the reflector extension 76 and the slot 75b, the main PWB 4 can be separately tuned to enhance the antenna operation in two low frequency bands.

While the stub reflector 74a and the reflector extension 76 shown are open ended, it is appreciated that each of them can also be grounded at its end.

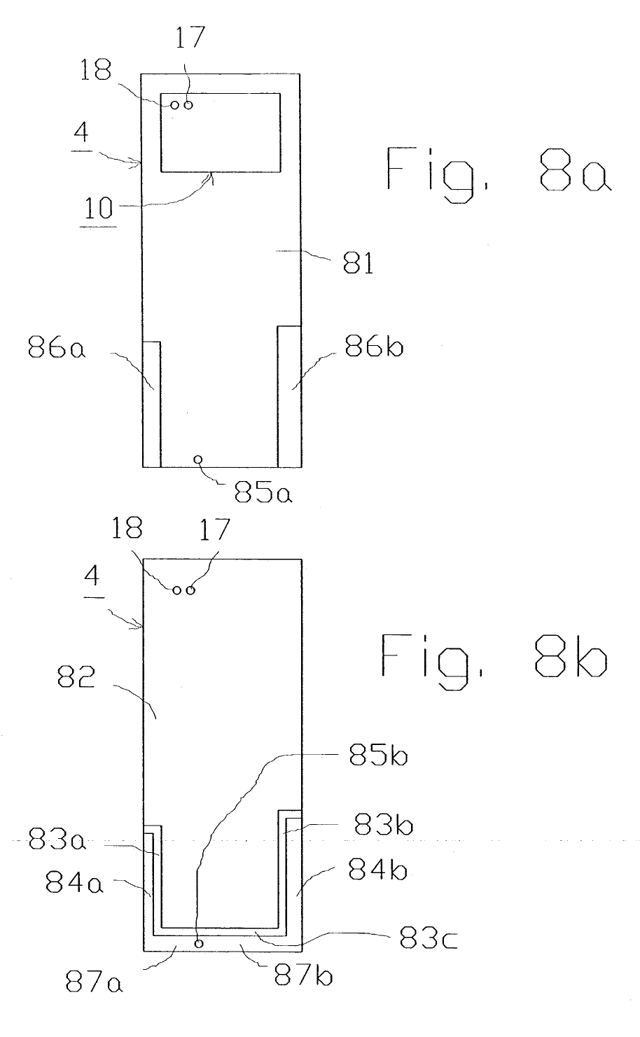

FIGS. 8a and 8b illustrate a construction similar to that of FIGS. 6a and 6b, except that the stub reflectors are asymmetrical, and the connections of the antenna 10 to the PWB 4 are by means of two terminals rather than three terminals. Thus, the internal antenna 10 carried by the PWB 4 includes a signal input terminal 17, but only a ground terminal 18 on one side of the latter terminal. The location of the terminal 18 can be changed as desired. In addition, the interruptions 86a, 86b formed in the conductive layer 81 on one side of the PWB 4, and the slots 83a, 83b, formed in the electrically-conductive layer 82 on the opposite face of the PWB are the same as the corresponding interruptions 66a, 66b and slots 63a, 63b in FIGS. 6a, 6b, except that they are asymmetrical. The electrical connections for exciting the stub reflectors 84a, 84b in the form of PTH 85a, 85b or the like, the electrical connections 87a, 87b electrically connecting conductive layer 81 to the stub reflectors are asymmetrical as well.

Other constructions for stub reflectors could be used. For example, the stub reflectors could be in the form of, or could include, discrete reactive elements, such as described in U.S. Pat. No. 5,068,670.

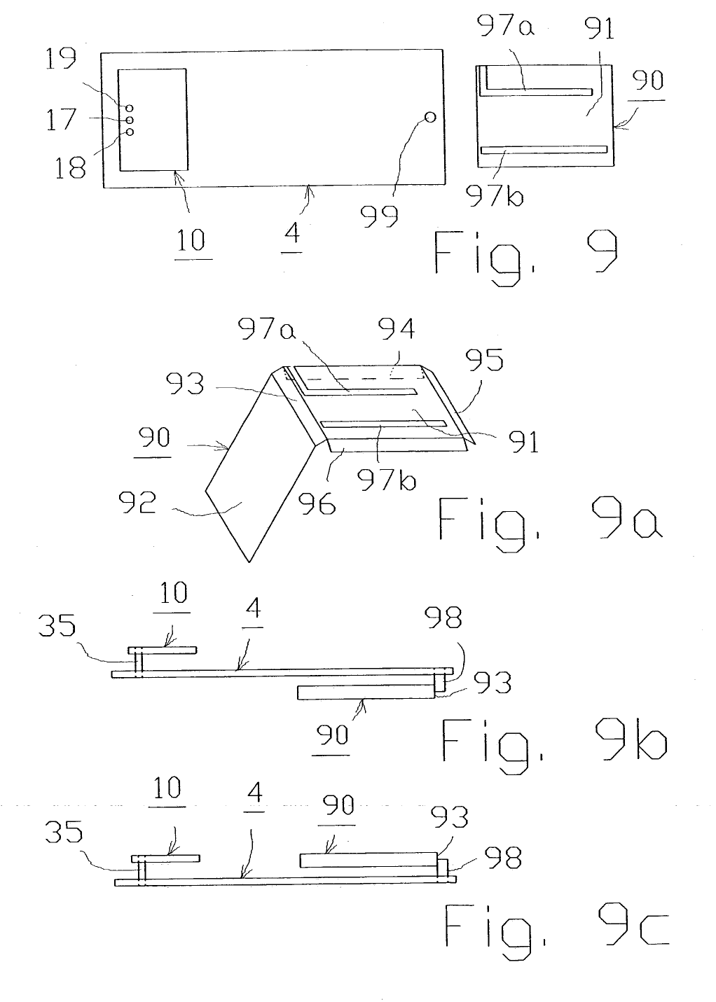

FIG. 9 illustrates a construction wherein the electrically-conductive reflector, therein designated 90, is in the form of a plural-sided, i.e., six-sided box to be carried by the end of the PWB 4 opposite to that carrying the internal antenna 10 and the signal input terminal 17 of that reflector. The six sides of box reflector 90 are shown at 91-96, respectively, in FIG. 9a. Side 91 includes an electrically-conductive layer formed with an open slot 97a, and a closed slot 97b. Side 93 is made completely electrically-conductive, whereas the remaining sides 92, 94, 95 and 96 are electrically insulating.

The reflector box 90 may be mounted below the PWB 4 (FIG. 9b) or above (FIG. 9c). In either case, its electrically-conductive layers (91, 93) are electrically connected to the electrically-conductive layer of the PWB 4 in any suitable manner, e.g., as by a spring-loaded conductive pin 98 passing through a plated-through-hole 99 in the PWB 4 and engaging electrically-conductive side 93.

As described above, the purpose of the electrically-conductive layers of the reflector 90 is to effectively enlarge the ground plane of the PWB 4 so as to load the antenna 10 in the lower radio frequency band, and thereby to enhance the operating efficiency of the antenna in the lower radio frequency band. The reflector box 90 may therefore have a different number or arrangement of electrically-conductive layers for effectively enlarging the ground of the PWB 4. Similarly, the slots 97a, 97b may be of different locations and/or configurations to improve the matching, and thereby to enhance the radiation of the antenna in the desired operational band. In some cases, only one slot, or no slots, may be provided.

In all the above-described embodiments of the invention, the antenna is an internal antenna. It will be appreciated, however, that the invention could also be implemented in mobile communication apparatus having external antennas.

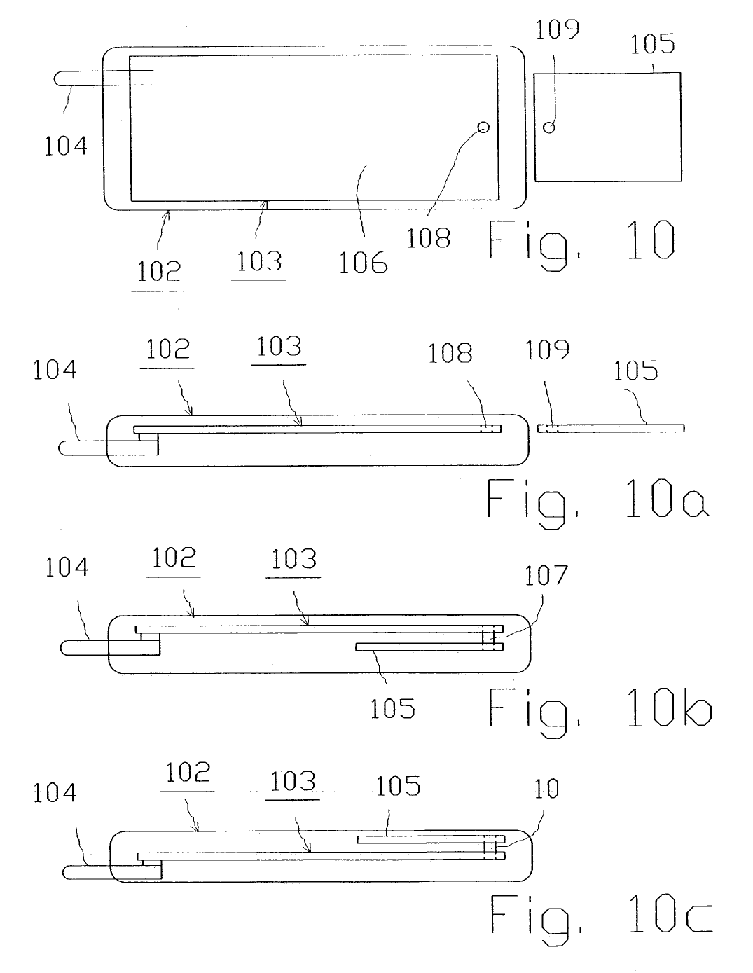

One such construction is illustrated in FIG. 10, wherein the housing is shown at 102, the PWB containing the communication circuitry of the apparatus is shown at 103, and the external antenna is shown at 104. The electrically-conductive reflector, shown at 105, for effectively enlarging the ground of the PWB 103 to load the antenna 104 in a lower radio frequency band may be any of the constructions described above. It is electrically connected to the ground conductive layer 106 at the opposite end of the PWB 103 connected to the antenna by a pin 107 passing through PTHs 108, 109 in the PWB and the reflector, respectively. The reflector 105 may be mounted to underlie the PWB 103 as shown in FIG. 10b, to overlie it as shown in FIG. 10c, or at any angle thereto.

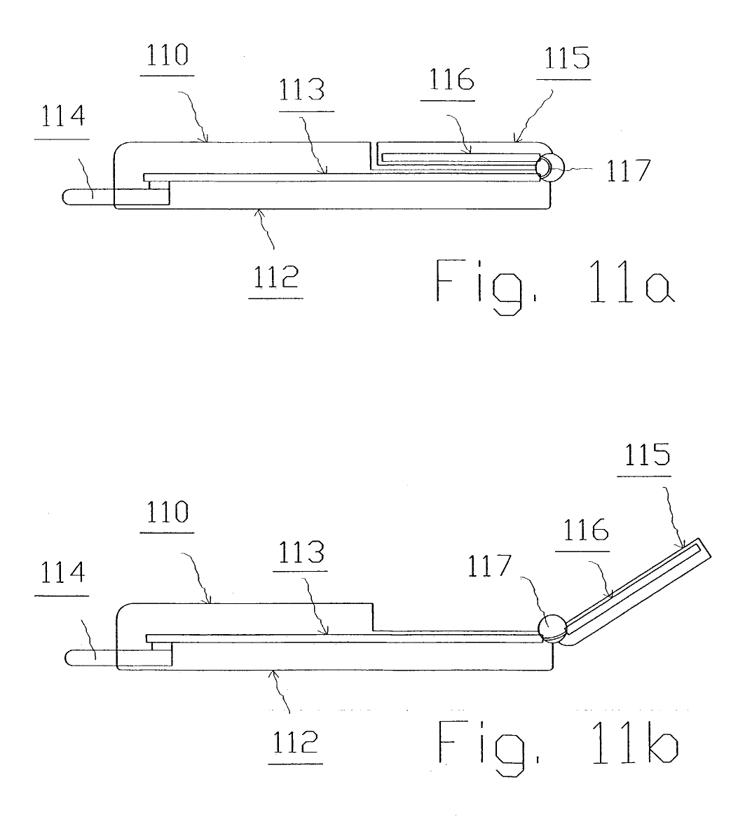

FIGS. 11a and 11b illustrate another implementation of the invention, in the form of a mobile telephone handset, generally designated 110, including a main housing 112 containing the main PWB 113, an external antenna 114, and a flip section 115 containing the microphone of the handset. In this embodiment of the invention, the reflector provided to effectively enlarge the ground of the PWB 113 is carried by the flip section 115 as shown at 116. The reflector 116 is electrically connected to the ground of the PWB 113 at its end opposite to that connected to the external antenna 114 in any suitable manner, e.g., by an electrically-conductive flexible 117 in the pivoted coupling of the flip section 115 to the housing 112.

Other constructions of mobile telephone handsets are known in which the housing has two sections movable relative to each other, (e.g., relatively slidable sections), in which the PWB, communication circuitry and signal terminal are in one section. The invention may also be implemented in those constructions, e.g., by including the electrically-conductive reflector in the other section.

While the invention has been described with respect to several preferred embodiments, it will be appreciated, therefore, that these are set forth merely for purposes of example, and that many other variations, modifications and applications of the invention may be made.

What is claimed is:

1. Mobile communication apparatus, comprising:
a housing including communication circuitry and a printed wired board (PWB) formed with a signal terminal for an antenna, and an electrically-conductive ground for said communication circuitry;
an antenna carried by said housing and electrically connected to said signal terminal of the communication circuitry in the PWB, said antenna being designed to operate in at least one radio frequency band;
and an electrically-conductive reflector carried by said PWB and electrically connected to said electrically-conductive ground of the PWB such that said electrically-conductive reflector effectively enlarges said ground of the PWB to load the antenna in said radio frequency band, and thereby to enhance the operating efficiency of the antenna particularly in the lower part of said radio frequency band, and/or to widen said radio frequency band.

2. The apparatus according to claim 1, wherein said antenna is connected to the signal terminal of the communication circuitry at one end of the PWB, and said electrically-conductive reflector is connected to the ground of the communication circuitry at the opposite end of said PWB.

3. The apparatus according to claim 2, wherein said reflector is carried on a separate board from said PWB and is electrically connected to the ground of the communication circuitry at said opposite end of the PWB.

4. The apparatus according to claim 3, wherein said reflector board is fixed to said PWB and underlies said opposite end of the PWB.

5. The apparatus according to claim 3, wherein said reflector board is fixed to said PWB and overlies said opposite end of the PWB.

6. The apparatus according to claim 3, wherein said reflector board is integrally formed with said PWB at said opposite end thereof, and is folded with respect to said opposite end of the PWB.

7. The apparatus according to claim 1, wherein said ground of the communication circuitry is carried on one layer of said PWB, and said reflector is carried on another layer of said PWB.

8. The apparatus according to claim 1, wherein said signal terminal of the communication circuitry is on one layer of the PWB at one end thereof, and said reflector is carried on another layer of the PWB at the opposite end thereof.

9. The apparatus according to claim 1, wherein said reflector includes at least one stub reflector carried by said PWB.

10. The apparatus according to claim 1, wherein said signal terminal of the communication circuitry is at one end of the PWB, and said reflector includes at least one stub reflector at the opposite end of the PWB.

11. The apparatus according to claim 10, wherein said reflector includes a pair of stub reflectors formed in the electrically-conductive ground of the PWB at said opposite end of the PWB.

12. The apparatus according to claim 11, wherein said opposite end of the PWB includes an electrically-conductive ground on one layer of the PWB, said stub reflectors being defined by slots formed in the electrically-conductive ground on said one layer.

13. The apparatus according to claim 12, wherein said PWB includes an electrically-conductive ground on a second layer of the PWB, said second layer being formed with interruptions in said electrically-conductive ground, which interruptions are aligned with said stub reflectors in said one layer.

14. The apparatus according to claim 12, wherein said stub reflectors include electrically-conductive portions on another layer of said PWB to which said stub reflectors are electrically connected.

15. The apparatus according to claim 1, wherein said electrically-conductive reflector is included in a box having a plurality of sides overlying one end of the PWB, at least one of said sides of the box being electrically-conductive and serving as the reflector electrically connected to said ground of the PWB.

16. The apparatus according to claim 15, wherein a plurality of said sides of said electrically-conductive reflector box are electrically-conductive and serve as the reflector electrically connected to said ground of the PWB.

17. The apparatus according to claim 15, wherein said at least one electrically-conductive side of said reflector box is formed with at least one slot to modify the load produced by said reflector box.

18. The apparatus according to claim 1, wherein said antenna is an internal antenna within said housing and is electrically connected to said PWB within said housing.

19. The apparatus according to claim 1, wherein said antenna is an external antenna carried by said housing externally thereof and is electrically connected to said PWB within said housing.

20. The apparatus according to claim 1, wherein said antenna is electrically connected to the ground of said PWB, in addition to its connection to the signal terminal of said PWB.

21. The apparatus according to claim 1, wherein said mobile communication apparatus is a mobile telephone handset and includes a housing having two sections movable relative to each other, one of said housing sections including said PWB, communication circuitry, and signal terminal for an antenna, the other of said housing sections including said electrically-conductive reflector.

22. The apparatus according to claim 21, wherein said other housing section is pivotal with respect to said one housing section.

23. A method of enhancing the operational efficiency of a mobile communication apparatus in at least one radio frequency band, or to widen its radio frequency band, which apparatus comprises a housing including communication circuitry and a printed wired board (PWB) formed with a signal terminal for an antenna and an electrically-conductive ground for said communication circuitry, and an antenna carried by said housing and electrically connected to said signal terminal of the communication circuitry in the PWB;
characterized in that the operating efficiency of the antenna is enhanced, particularly in the lower portion of said radio frequency band, or its radio frequency band is widened by connecting an electrically-conductive reflector to said electrically-conductive ground of the PWB such that said electrically-conductive reflector effectively enlarges said ground of the PWB to load the antenna in said radio frequency band.

24. The method according to claim 23, wherein said antenna is connected to the signal terminal of the communication circuitry at one end of the PWB, and said electrically-conductive reflector is connected to the ground of the communication circuitry at the opposite end of said PWB.

25. The method according to claim 24, wherein said reflector is carried on a separate board from said PWB and is electrically connected to said opposite end of the PWB.

26. The method according to claim 23, wherein said ground of the communication circuitry is carried on one layer of said PWB, and said reflector is carried on another layer of said PWB.

27. The method according to claim 23, wherein said signal terminal of the communication circuitry is on one layer of the PWB at one end thereof, and said reflector is carried on another layer of the PWB at the opposite end thereof.

28. The method according to claim 23, wherein said reflector includes at least one stub reflector carried by said PWB.

29. The method according to claim 23, wherein said antenna is an internal antenna within said housing and is electrically connected to said PWB within said housing.

30. The method according to claim 23, wherein said antenna is an external antenna carried by said housing externally thereof and is electrically connected to said PWB within said housing.

31. The method according to claim 23, wherein said antenna is electrically connected to the ground of said PWB, in addition to its connection to the signal terminal of said PWB.

32. The method according to claim 23, wherein said mobile communication apparatus is a mobile telephone handset and includes a housing having two sections movable relative to each other, one of said housing sections including said PWB, communication circuitry, and signal terminal for an antenna, the other of said housing sections including said electrically-conductive reflector.

33. The method according to claim 23, wherein said electrically-conductive reflector is formed with slots to modify the load produced thereby.
